(19) United States
(12) Patent Application Publication
(10) Pub. No.: US 2018/0372112 A1
(43) Pub. Date: Dec. 27, 2018

(54) HEAT EXCHANGE SYSTEM FOR A TURBOMACHINE AND AN ASSOCIATED METHOD THEREOF

(71) Applicant: GENERAL ELECTRIC COMPANY, Schenectady, NY (US)

(72) Inventors: Deoras Prabhudharwadkar, Jebel Ali (AE); David Richard Johns, Simpsonville, SC (US)

(21) Appl. No.: 15/629,036

(22) Filed: Jun. 21, 2017

(51) Int. Cl. F04D 29/12; F02C 3/04; F02C 9/18; F04D 29/52; F04D 29/053; F04D 29/54; F01D 25/24

(52) U.S. Cl. CPC F04D 29/124; F02C 3/04; F02C 9/18; F04D 29/522; F04D 29/053; F04D 29/541; F05D 2250/283; F05D 2220/32; F05D 2240/35; F05D 2240/60; F05D 2260/208; F05D 2260/232; F01D 25/24

(57) ABSTRACT

A turbomachine and a heat exchange system for the turbomachine are disclosed. The turbomachine includes a stationary component, a rotatable component, an abradable seal component, and a plurality of heat dissipating elements. The rotatable component includes teeth. The abradable seal component is operatively coupled to a surface of the stationary component and disposed facing the teeth to define a clearance there between the abradable seal component and the rotatable component. The plurality of heat dissipating elements is coupled to the abradable seal component. Each of the plurality of heat dissipating elements extends from the abradable seal component through the surface of the stationary component to a turbomachine cavity.

### BACKGROUND

Embodiments of the disclosed technique relate to turbomachines, and more specifically to a heat exchange system coupled to an abradable seal component for regulating windage heating in turbomachines.

Sealing components are often used to minimize leakage of fluid in a clearance defined between a stationary component and a rotatable component of a turbomachine. Typically, the sealing components includes teeth formed on the rotatable component, which are configured to obstruct a flow of the fluid and minimize the leakage of the fluid through the clearance. However, during certain transient operational conditions of the turbomachine, such as startup, the rotatable component may move along an axial direction or a radial direction in relation to the stationary component. Such movement of the rotatable component may cause the teeth to rub against the stationary component, resulting in damage of the teeth and the stationary component. To address such problems, in the art, an abradable component including a plurality of honeycomb cells is often coupled to the stationary component. Thus, during such movement of the rotatable component, the teeth may rub against the abradable seal component, without damaging the teeth and the stationary component. However, the plurality of honeycomb cells in the abradable seal component may entrap some portion of the fluid, resulting in loss of the swirling motion of the fluid along the clearance and increasing tangential slip between the fluid and the rotatable component, thereby increasing windage heating along the clearance. Accordingly, there is a need for a heat exchange system and an associated method for regulating windage heating along a clearance of a turbomachine.

### BRIEF DESCRIPTION

In accordance with one example embodiment, a turbomachine is disclosed. The turbomachine includes a stationary component, a rotatable component, an abradable seal component, and a plurality of heat dissipating elements. The rotatable component includes teeth. The abradable seal component is operatively coupled to a surface of the stationary component and disposed facing the teeth to define a clearance there between the abradable seal component and the rotatable component. The plurality of heat dissipating elements is coupled to the abradable seal component. Each of the plurality of heat dissipating elements extends from the abradable seal component through the surface of the stationary component to a turbomachine cavity.

In accordance with another example embodiment, a heat exchange system for a turbomachine including a compressor and a turbine is disclosed. The heat exchange system includes a bypass flow path, an abradable seal component, and a plurality of heat dissipating elements. The bypass flow path is defined between a portion of a compressor discharge casing and a shaft. The shaft is coupled to the turbine and the compressor, and a portion of the shaft includes teeth. The abradable seal component is operatively coupled to a surface of the compressor discharge casing and facing the teeth to define a clearance there between the abradable seal component and the shaft. The plurality of heat dissipating elements is coupled to the abradable seal component. Each of the plurality of heat dissipating elements extends from the abradable seal component through the surface of the compressor discharge casing to a turbomachine cavity. The plurality of heat dissipating elements is configured to transfer at least a portion of heat away from a flow of a bypass compressed fluid in the bypass flow path.

### DRAWINGS

These and other features and aspects of embodiments of the disclosed technique will become better understood when the following detailed description is read with reference to the accompanying drawings in which like characters represent like parts throughout the drawings, unless specifically recited otherwise, wherein:

FIG. 1 is a cross-sectional view of a turbomachine in accordance with one example embodiment of the present disclosure.

FIG. 2 is a schematic cross-sectional view of a portion of the turbomachine including a heat exchange system in accordance with one example embodiment of the present disclosure.

FIG. 3 is a perspective view of a plurality of heat pipes in accordance with one example embodiment of the present disclosure.

FIG. 4 is a schematic cross-sectional view of a plurality of heat dissipating elements coupled to a backing plate and a support structure in accordance with one example embodiment of the present disclosure.

FIG. 5 is a schematic side view of a portion of a heat pipe and an abradable seal component in accordance with one example embodiment of the present disclosure.

FIG. 6 is a schematic side view of a vapor chamber and an abradable seal component in accordance with one example embodiment of the present disclosure.

FIG. 7 is a flow diagram of regulating windage heating along clearance of a turbomachine in accordance with one example embodiment of the present disclosure.

### DETAILED DESCRIPTION

To more clearly and concisely describe and point out the subject matter, the following definitions are provided for specific terms, which are used throughout the following description and the appended claims, unless specifically denoted otherwise with respect to a particular embodiment. The term “operatively coupled” as used in the context refers to connecting at least two components to each other such that they function together in a mutually compatible manner to perform an intended operation. For example, a plurality of heat dissipating elements is connected to an abradable seal component via a backing plate such that the abradable component and the plurality of heat dissipating elements function together in a mutually compatible manner, for example, for dissipating heat such as windage heat away from a clearance to a turbomachine cavity. The term “main compressed fluid” as used in the context refers to a major portion of a compressed fluid discharged from a compressor of a turbomachine. In some embodiments, the major portion means more than 80 percent of the compressed fluid. In some other embodiments, the major portion means more than 50 percent of the compressed fluid. Similarly, the term “main flow path” refers to a flow path extending from the compressor to a combustor of the turbomachine. The term “bypass compressed fluid” as used in the context refers to a minor portion of the compressed fluid discharged from the compressor. In some embodiments, the minor portion means less than 20 percent of the compressed fluid. In some other embodiments, the minor portion means less than 50 percent of the compressed fluid. Similarly, the term “bypass flow path” refers to a flow path extending from the compressor to a turbine of the turbomachine, bypassing the combustor.

Embodiments of the present disclosure discussed herein relate to a turbomachine, such as a gas turbine engine, including a plurality of heat dissipating elements configured to regulate windage heating of the turbomachine. The turbomachine includes a stationary component, a rotatable component including teeth, an abradable seal component, and the plurality of heat dissipating elements. In some embodiments, the abradable seal component is operatively coupled to a surface of the stationary component and disposed facing the teeth to define a clearance there between the abradable seal component and the rotatable component. The plurality of heat dissipating elements is coupled to the abradable seal component. Each of the plurality of heat dissipating elements extends from the abradable seal component through the surface of the stationary component to a turbomachine cavity. In certain embodiments, the abradable seal component includes a backing plate coupled to the surface of the stationary component. In one such example embodiment, the abradable seal component is operatively coupled to the stationary component through the backing plate. In one or more embodiments, the plurality of heat dissipating elements is configured to transfer windage heat generated along the clearance to the turbomachine cavity.

In some embodiments, the abradable seal component is a labyrinth seal component disposed at one location of the turbomachine. In some embodiments, the location is a first flow path (e.g., a bypass flow path) extending from a compressor to a turbine of the turbomachine, bypassing the combustor. In one such example embodiment, the turbomachine cavity is a compressor discharge cavity defined by at least a portion of a compressor discharge casing of the turbomachine. In some other embodiments, the location is a second flow path extending between a tip of the respective rotor blades and a turbine casing of the turbomachine. In one such example embodiment, the turbomachine cavity is a tip shroud cavity defined by the turbine casing. In some other embodiments, the abradable seal component is an inter-stage seal component disposed at the location such as a third flow path defined between a rotor, a stator, and a spacer wheel of the turbine. In one such example embodiment, the turbomachine cavity is a diaphragm cavity defined by a stator diaphragm of the stationary component such as the stator of the turbine.

In some embodiments, the abradable seal component includes a plurality of honeycomb cells disposed adjacent to each other along an axial direction and a circumferential direction of the turbomachine. In one such example embodiment, each honeycomb cell may include a plurality of radial sidewalls, where each radial sidewall includes a first portion coupled to the surface of the stationary component and a second portion extending from the first portion towards the clearance defined between there between the abradable seal component and the rotatable component. The second portion may be bent relative to a radial axis of the turbomachine. In some other embodiments, the abradable seal component includes a plurality of annular rings spaced apart from each other and disposed along the axial direction. In some embodiments, at least one of the plurality of heat dissipating elements includes a heat pipe. In some other embodiments, at least one of the plurality of heat dissipating elements includes a vapor chamber.

In one example embodiment, during operation of the turbomachine, the compressor is configured to discharge a main compressed fluid to the combustor via a main flow path. The compressor is further configured to release bypass compressed fluid to the turbine via a first flow path (a bypass flow path). In one embodiment, the abradable seal component is configured to regulate the flow of the bypass compressed fluid along the clearance and also function as fins to transport a portion of heat generated by the bypass compressed fluid towards the plurality of heat dissipating elements. In one such example embodiment, the plurality of heat dissipating elements is configured to further transfer at least the portion of heat to the main compressed fluid in a compressor discharge cavity, thereby effectively regulating temperature of the bypass compressed fluid in the clearance. Thus, the employment of the plurality of heat dissipating elements may allow the compressor to reduce an amount of the bypass compressed fluid released to the turbine. Consequently, allowing the compressor to increase an amount of the main compressed fluid discharged to the combustor, and thereby improving efficiency of the compressor. Further, effective regulation of the temperature in the clearance may allow the compressor to optimize a compression ratio of the compressed fluid. It should be noted herein that the term “compression ratio” refers to a ratio of an absolute stage discharge pressure to the absolute stage suction pressure. In some embodiments, an optimal compression ratio may be in a range from 8:1 to 30:1. In some other embodiments, the optimal compression ratio may be 14:1 to 24:1. Further, the plurality of heat dissipating elements may indirectly improve life duration of the downstream components such as an angel wing and a rub-strip of an intra-stage seal, which are located downstream of the abradable seal component.

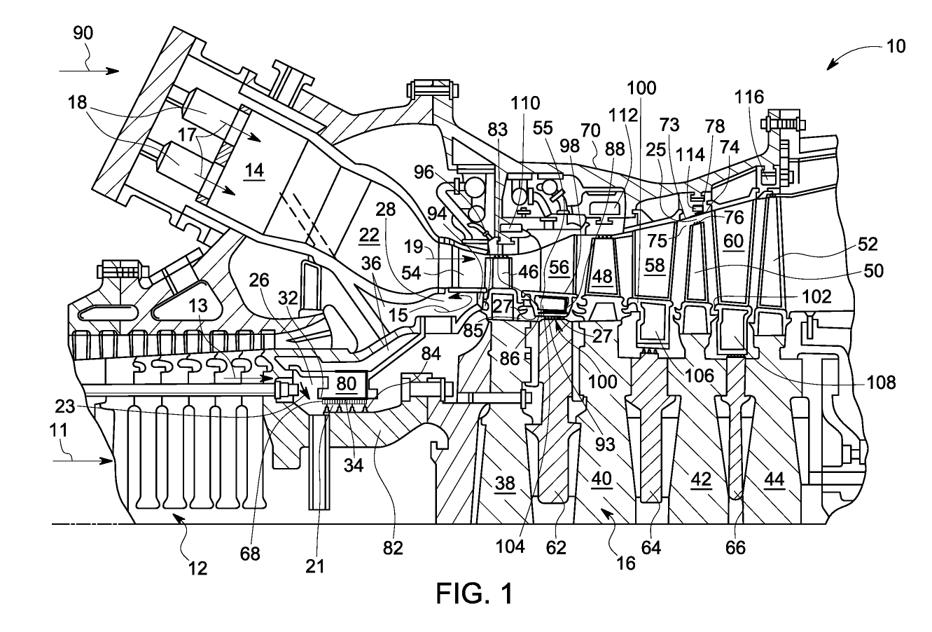

FIG. 1 illustrates a cross-sectional view of a turbomachine 10, such as a gas turbine engine in accordance with one example embodiment. The turbomachine 10 includes a compressor 12, a combustor 14, and a turbine 16. In the illustrated embodiment, the compressor 12 is a multistage compressor and the turbine 16 is a multistage turbine. The compressor 12 is coupled to the combustor 14. The turbine 16 is coupled to the combustor 14 and the compressor 12. In some embodiments, the turbomachine 10 includes a main flow path 28 extending from the compressor 12 to the combustor 14 and a first flow path such as a bypass flow path 26 extending from the compressor 12 to the turbine 16 bypassing the combustor 14.

In the illustrated embodiment, the turbine 16 includes four-stages represented by four rotors 38, 40, 42, 44 that are connected to a shaft such as a mid-shaft 82 for rotation therewith. Each of the four rotors 38, 40, 42, 44 includes airfoils such as rotor blades 46, 48, 50, 52 that are arranged alternately between nozzles such as stator blades 54, 56, 58, 60 respectively. The stator blades 54, 56, 58, 60 are fixed to a turbine casing 70 of the turbine 16. The stator blade 54 includes a support ring 94 which defines a wheel space cavity 96 between the stator blade 54 and the rotor 38. The plurality of stators blades 56, 58, 60 includes stator diaphragms 98, 100, 102 respectively. The stator diaphragms 98, 100, 102 define respective diaphragm cavities 104, 106, 108. The turbine 16 further includes three spacer wheels 62, 64, 66 coupled to and disposed alternately between rotors 38, 40, 42, 44. The turbine 16 includes a first stage having the stator blade 54 and the rotor blade 46, a second stage having the stator blade 56, the spacer wheel 62, and the rotor blade 48, a third stage having the stator blade 58, the spacer wheel 64, and the rotor blade 50, and a fourth stage having the stator blade 60, the spacer wheel 66, and the rotor blade 52. The turbomachine 10 further includes tip shroud cavities 110, 112, 114, 116 defined by the turbine casing 70. The tip shroud cavities 110, 112, 114, 116 are located proximate to the tip of respective rotors blades 46, 48, 50, 52.

The turbomachine 10 further includes a stationary component such as a compressor discharge casing 80, a rotatable component such as the mid-shaft 82, and an abradable seal component 68. In one such example embodiment, the abradable seal component 68 is disposed at a location such as the bypass flow path 26 (i.e., a first flow path). In one embodiment, the abradable seal component 68 is a labyrinth seal component. In the illustrated embodiment, the abradable seal component 68 is operatively coupled to a surface 32 of the compressor discharge casing 80 facing the mid-shaft 82 having teeth 84 to define a clearance 21 there between the compressor discharge casing 80 and the mid-shaft 82. For example, the clearance 21 is defined between the compressor discharge casing 80 and the mid-shaft 82. In some embodiments, the abradable seal component 68 may include a plurality of honeycomb cells or a plurality of annular rings (not shown). Further, the abradable seal component 68 may include a plurality of grooves (not shown) which may be spaced apart from each other along an axial direction 90 of the turbomachine 10.

The turbomachine 10 further includes a plurality of heat dissipating elements 34 coupled to the abradable seal component 68. In some embodiments, the plurality of heat dissipating elements 34 is coupled to an end portion (e.g., a first end portion) of the abradable seal component 68, which is away from the teeth 84. In other words, the end portion is opposite to another end portion (e.g., a second end portion) of the abradable seal component 68 facing the teeth 84. Each of the plurality of heat dissipating elements 34 extends from the abradable seal component 68 through the surface 32 of the compressor discharge casing 80 to a turbomachine cavity such as a compressor discharge cavity 36. In some embodiments, at least one of the plurality of heat dissipating elements 34 may be a heat pipe. In some other embodiments, a majority of the plurality of heat dissipating elements 34 may be a heat pipe. In some example embodiments, all of the plurality of heat dissipating elements 34 may be heat pipes. In some other embodiments, at least one of the plurality of heat dissipating elements 34 may be a vapor chamber. In some other embodiments, a majority of the plurality of heat dissipating elements 34 may be a vapor chamber. In some example embodiments, all of the plurality of heat dissipating elements 34 may be vapor chambers.

The turbomachine 10 further includes a stationary component such as the turbine casing 70, a rotatable component such as the rotor blade 50, and an abradable seal component 74. In one such example embodiment, the abradable seal component 74 is disposed at another location such as a second flow path 75 extending between a tip of the rotor blade 50 and the turbine casing 70. In some example embodiments, the abradable seal component 74 may be a labyrinth seal component. The abradable seal component 74 is operatively coupled to a surface 73 of the turbine casing 70 facing teeth 76 formed at the tip of the rotor blade 50 to define a clearance 25 there between the tip of the rotor blade 50 and the turbine casing 70. In some embodiments, the abradable seal component 74 may include a plurality of honeycomb cells or a plurality of annular rings (not shown). The abradable seal component 74 may be similar to the abradable seal component 68. In one such example embodiment, the turbomachine 10 further includes a plurality of heat dissipating elements 78 coupled to the abradable seal component 74. Each of the plurality of heat dissipating elements 78 extends from the abradable seal component 74 via the surface 73 of the turbine casing 70 to a turbomachine cavity such as the tip shroud cavity 114. Although not illustrated, in certain embodiments, the abradable seal component 74 may be coupled to the turbine casing 70 facing teeth of respective rotor blades 46, 48, 52 to define a clearance there between the respective rotor blades 46, 48, 52 and the turbine casing 70. In such embodiments, the plurality of heat dissipating elements 78 may be coupled to the respective abradable seal component 74.

The turbomachine 10 further includes a stationary component such as the stator blade 56, a rotatable component such as the spacer wheel 62, and an abradable seal component 86. In one such embodiment, the abradable seal component 86 is disposed at yet another location such as a third flow path 85 extending between a tip of the stator blade 56 and the spacer wheel 62. In one such example embodiment, the abradable seal component 86 may be an inter-stage seal component. The abradable seal component 86 may be operatively coupled to a surface 83 of the stator blade 56 facing teeth 93 formed in the spacer wheel 62 to define a clearance 27 there between the tip of the stator blade 56 and the spacer wheel 62. In some embodiments, the abradable seal component 86 may include a plurality of honeycomb cells or a plurality of annular rings (not shown). The abradable seal component 86 may be similar to the abradable seal component 68. In one such example embodiment, the turbomachine 10 further includes a plurality of heat dissipating elements 88 coupled to the abradable seal component 86. Each of the plurality of heat dissipating elements 88 extends from the abradable seal component 86 via the surface 83 of the turbine casing 70 to a turbomachine cavity such as the diaphragm cavity 104. Although not illustrated, the abradable seal component 86 may be coupled to the tip of the respective stator blades 58, 60 facing teeth formed in the respective spacer wheels 64, 66. In such embodiments, the plurality of heat dissipating elements 88 may be coupled to the respective abradable seal component 86.

During operation, the compressor 12 is configured to receive a fluid 11, such as air, and compress the fluid 11 to generate a compressed fluid 13, which may have a swirling motion. The combustor 14 is configured to receive a main compressed fluid 15 from the compressor 12 via the main flow path 28 and a fuel 17, such as natural gas, from a plurality of fuel injectors 18, and burn the fuel 17 and the main compressed fluid 15 within a combustion zone 22 to generate exhaust gas stream 19. The turbine 16 is configured to receive the exhaust gas stream 19 from the combustor 14 and expand the exhaust gas stream 19 through multiple stages of the turbine 16 to convert energy present in the exhaust gas stream 19 to work. The turbine 16 is configured to drive the compressor 12 through a rotatable component such as a mid-shaft 82. The compressor 12 is further configured to release a bypass compressed fluid 23 to the turbine 16 via the bypass flow path 26.

In some embodiments, the plurality of honeycomb cells or the plurality of annular rings of the abradable seal component 68 may entrap a portion of the bypass compressed fluid 23, thereby de-swirl the swirling motion of the bypass compressed fluid 23 and increase the windage heating along the clearance 21 of the turbomachine 10. In one such example embodiment, the plurality of heat dissipating elements 34 is configured to regulate windage heating along the clearance 21 by transferring at least a portion of heat from the bypass compressed fluid 23 to the main compressed fluid 15 in the compressor discharge cavity 36. Further, the abradable seal component 68 may be configured to control leakage of the bypass compressed fluid 23 through the clearance 21. The abradable seal component 68 and the plurality of heat dissipating elements 34 are discussed in greater detail below with reference to subsequent figures.

In some other embodiments, the plurality of honeycomb cells or the plurality of annular rings of the respective abradable seal component 74, 86 may entrap a portion of the exhaust gas stream 19, thereby de-swirl the swirling motion of the exhaust gas stream 19 and increase the windage heating along the clearance 25, 27 respectively of the turbomachine 10. In one such example embodiment, the plurality of heat dissipating elements 78, 88 is configured to regulate windage heating along the clearance 25, 27 respectively by transferring at least a portion of heat from the exhaust gas stream 19 to a cooling fluid such as the main compressed fluid 15 (not labeled) in the tip shroud cavity 114, the diaphragm cavity 104 respectively. Further, the abradable seal component 74, 86 may be configured to control leakage of the exhaust gas stream 19 through the clearance 25, 27 respectively.

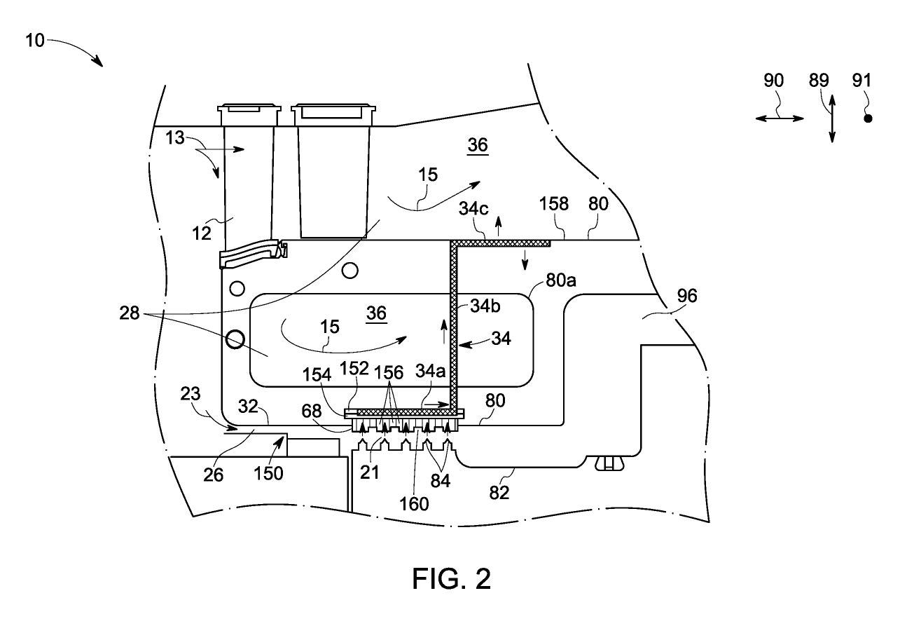

FIG. 2 illustrates a schematic cross-sectional view of a portion of the turbomachine 10 including a heat exchange system 150 in accordance with one example embodiment. The heat exchange system 150 includes a bypass flow path 26 (a first flow path) defined between a portion of a compressor discharge casing 80 of a compressor 12 and a mid-shaft 82. It should be noted herein that only a portion of the compressor 12 and the mid-shaft 82 are shown in FIG. 2 for ease of illustration and such an illustration should not be construed as a limitation of the present disclosure. In one embodiment, the mid-shaft 82 is coupled to compressor 12 and to a rotor 38 of a turbine 16 (as shown in FIG. 1).

The heat exchange system 150 further includes an abradable seal component 68 operatively coupled to the compressor discharge casing 80 and facing teeth 84 to define a clearance 21 there between the abradable seal component 68 and the mid-shaft 82. In the illustrated embodiment, the turbomachine 10 further includes a backing plate 152 coupled to a surface 32 of the compressor discharge casing 80. The abradable seal component 68 is operatively coupled to the compressor discharge casing 80 via the backing plate 152. In this embodiment, the abradable seal component 68 is disposed in a slot 154 defined by the backing plate 152 and then the abradable seal component 68 is brazed to the backing plate 152. The abradable seal component 68 includes a plurality of honeycomb cells 156 disposed adjacent to each other along an axial direction 90 and a circumferential direction 91 of the turbomachine 10. In the illustrated embodiment, the abradable seal component 68 further includes a plurality of grooves 160 spaced apart from each other along the axial direction 90 and extending along the circumferential direction 91.

The heat exchange system 150 further includes a plurality of heat dissipating elements 34 operatively coupled to the abradable seal component 68 via the backing plate 152. It should be noted herein that only one heat dissipating element of the plurality of heat dissipating elements 34 is shown in FIG. 2. In this embodiment, the plurality of heat dissipating elements 34 is disposed in the backing plate 152 and coupled to the backing plate 152. The abradable seal component 68 is coupled to the portion of the backing plate 152 including the plurality of heat dissipating elements 34. In some embodiments, at least one of the plurality of heat dissipating elements 34 is a vapor chamber. In some other embodiments, at least one of the plurality of heat dissipating elements 34 is a heat pipe. In some other embodiments, all or a majority of the plurality of heat dissipating elements 34 may be heat pipes or a vapor chambers. In some such example embodiments, the heat pipe includes an evaporator portion 34a, a transport portion 34b, and a condenser portion 34c coupled to one another. The evaporator portion 34a is disposed facing the abradable seal component 68. The transport portion 34b extends away from the evaporator portion 34a via the surface 32 of the compressor discharge casing 80. In example embodiment, the transport portion 34b extends through an inner barrel 80a of the compressor discharge casing 80. The condenser portion 34c extends from the transport portion 34b and is disposed in the compressor discharge cavity 36. In one embodiment, the evaporator portion 34a may be coupled to the backing plate 152 using clamping devices such as bolts, and the condenser portion 34c may be coupled to an intermediate wall 158 of the compressor discharge casing 80 using the clamping devices such as bolts.

During operation, the compressor 12 is configured to receive a fluid 11, such as air, and compress the fluid 11 to generate compressed fluid 13. In one or more embodiments, the compressor 12 is configured to discharge a main compressed fluid 15 along a main flow path 28 to a combustor 14 (as shown in FIG. 1). In one such example embodiment, the main compressed fluid 15 may be temporarily stored in the compressor discharge cavity 36 to efficiently expand the main compressed fluid 15 to recover a majority of the dynamic head before discharging the main compressed fluid 15 to the combustor 14. It should be noted herein that the term “dynamic head” means a total equivalent height that the main compressed fluid 15 needs to be pumped in the compressor discharge casing 36, considering friction losses along the compressor discharge casing 36. The combustor 14 may further receive a fuel 17 (as shown in FIG. 1) and burn a mixture of the fuel 17 and the main compressed fluid 15 to generate an exhaust gas stream 19 (as shown in FIG. 1). The turbine 16 (as shown in FIG. 1) is configured to receive the exhaust gas stream 19 from the combustor 14 and expand the exhaust gas stream 19 through multiple stages of the turbine 16 to convert energy present in the exhaust gas stream 19 to work.

In one embodiment, the compressor 12 is configured to release a bypass compressed fluid 23 to the turbine 16 via the bypass flow path 26. For example, the bypass compressed fluid 23 released from the compressor 12 is directed to the wheel space cavity 96 through the abradable seal component 68. Further, the bypass compressed fluid 23 is directed from the wheel space cavity 96 to the rotor blade 46 through an intra-stage seal (not shown in FIG. 2) of the turbomachine 10. In one or more embodiments, the abradable seal component 68, the plurality of grooves 160, and the teeth 84 are configured to regulate a flow of the bypass compressed fluid 23 along the clearance 21. The regulation of the bypass compressed fluid 23 may result in generating windage heat along the clearance 21. For example, the plurality of honeycomb cells 156 may entrap some portion of the bypass compressed fluid 23 resulting in losing swirling motion of the bypass compressed fluid 23 along the clearance 21 and increasing tangential slip between the compressed fluid 23 and the mid-shaft 82, thereby increasing windage heating in the clearance 21. In some such embodiments, the temperature of the bypass compressed fluid 23 along the clearance 21 and/or in the wheel space cavity 96 are substantially higher than temperature of the main compressed fluid 15 in the compressor discharge cavity 36. In accordance with one or more embodiments of the disclosed technique, the abradable seal component 68 functions as fins to transport a portion of windage heat generated by the bypass compressed fluid 23 towards the plurality of heat dissipating elements 34. In such an example embodiment, the plurality of heat dissipating elements 34 is configured to transfer at least the portion of the windage heat away from the bypass compressed fluid 23 in the bypass flow path 26. For example, the plurality of heat dissipating elements 34 is configured to transfer at least the portion of windage heat from the bypass compressed fluid 23 in the bypass flow path 26 to the main compressed fluid 15 in the main flow path 28 to regulate the temperature along the clearance 21 and/or the wheel space cavity 96. In one example embodiment, during operation, a working fluid (not shown) in the evaporator portion 34a may absorb the heat from the bypass compressed fluid 23 via the abradable seal component 68 and the backing plate 152. The transport portion 34b may transport the working fluid from the evaporator portion 34a to the condenser portion 34c. The condenser portion 34c may dissipate the heat to the main compressed fluid 15 via the intermediate wall 158 and may return the working fluid to the evaporator portion 34a. The plurality of heat dissipating elements 34 such as the heat pipe and/or vapor chamber are discussed in greater detail below with reference to subsequent figures.

In one or more embodiments, the plurality of heat dissipating elements 34 configured to regulate the temperature of the bypass compressed fluid 23 allows the compressor 12 to reduce the amount of the bypass compressed fluid 23 released to the turbine 16 and increase the amount of the main compressed fluid 15 discharged to the combustor 14, thus increasing efficiency of the compressor 12. Further, effective regulation of the temperature along the clearance 21 and/or the wheel space cavity 96 may allow the compressor 12 to optimize the compression ratio of the compressed fluid 13. The plurality of heat dissipating elements 34 may indirectly improve life of the downstream components such as angel wings and rub strips (not shown in FIG. 2) disposed in the intra-stage seal of the turbomachine 10. In one or more embodiments, temperature reduction of about 20 degrees Fahrenheit along the clearance 21 and/or the wheel space cavity 96 allows the compressor 12 to reduce the amount of the bypass compressed fluid 23 released to the turbine 16 by about 20 percent.

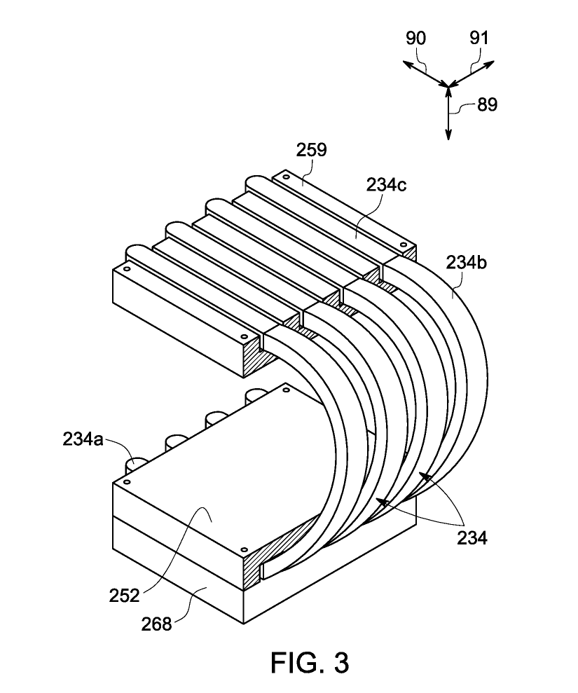

FIG. 3 illustrates a perspective view of a plurality of heat pipes 234 in accordance with one example embodiment. In the illustrated embodiment, the plurality of heat pipes 234 is spaced apart from each other along a circumferential direction 91 of a turbomachine. Further, the plurality of heat pipes 234 is coupled to a portion of a heat source such as a backing plate 252 and to a portion of a heat sink such as support structure 259 (or coupled to an intermediate wall of the compressor discharge casing). The backing plate 252 is coupled to an abradable seal component 268. In such example embodiment, the plurality of heat pipes 234 is operatively coupled to the abradable seal component 268 via the backing plate 252. It should be noted herein that the portion of the backing plate 252 and the portion of the support structure 259 are shown as having a flat structure for illustration purpose only. In some other embodiments, the portion of the backing plate 252 and the portion of the support structure 259 may have a curved shape matching to a shape of that of a stationary component such as the compressor discharge casing and the intermediate wall of the compressor discharge casing respectively. Each of the plurality of heat pipes 234 may include an evaporator portion 234a, a transport portion 234b, and a condenser portion 234c. In the illustrated embodiment, the evaporator portion 234a is disposed within the backing plate 252, the condenser portion 234c may be located in a compressor discharge cavity, and the transport portion 234b may extend through the compressor discharge casing. Each of the plurality of heat pipes 234 may be flexible in nature, thereby allowing the respective heat pipes 234 to be inserted through the compressor discharge casing and bent along respective peripheral side portions of the support structure 259 and respective peripheral side portions of the backing plate 252 respectively. In one such example embodiment, ends of the each of the plurality of heat pipes 234 are hermetically sealed using appropriate sealing techniques, thereby concealing working fluid within the respective heat pipes 234.

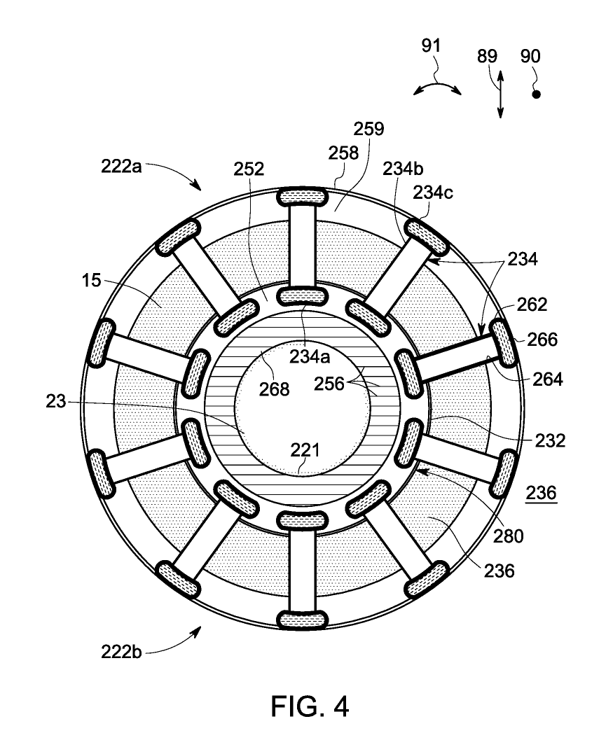

FIG. 4 illustrates a schematic cross-sectional view of a plurality of heat dissipating elements such as a plurality of heat pipes 234 coupled to a backing plate 252 and a support structure 259 in accordance with one example embodiment. As discussed in the embodiment of FIG. 3, each of the plurality of heat pipes 234 may include an evaporator portion 234a, a transport portion 234b, and a condenser portion 234c. In the illustrated embodiment, an abradable seal component 268 is coupled to the backing plate 252 such that the evaporator portion 234a is operatively coupled to the abradable seal component 268. The support structure 259 is coupled to an intermediate wall 258 of the compressor discharge casing 280 such that a portion of the condenser portion 234c is coupled to the intermediate wall 258. The transport portion 234b extends through the surface 232 of the compressor discharge casing 280 and is disposed in the compressor discharge cavity 236.

In the illustrated embodiment, the abradable seal component 268 includes a plurality of annular rings 256 spaced apart from each other and disposed along an axial direction 90 of a turbomachine. It should be noted herein that the plurality of annular rings 256 may be easier to assemble in the abradable seal component 268 in comparison with manufacturing the abradable seal component with the plurality of honeycomb cells. Further, the plurality of annular rings 256 may define a passage between mutually adjacent annular rings 256, thereby entrapping a portion of a fluid flowing along a clearance 221 into the passage for regulating the flow of the fluid along the clearance 221. In some other embodiments, the abradable seal component 268 may include a plurality of honeycomb cells.

Each of the plurality of heat pipes 234 may include a casing 262 and a wick 264 disposed within the casing 262. Further, each of the plurality of heat pipes 234 includes a sealed chamber enclosed by the wick 264 and a working fluid 266 filled within the sealed chamber. In certain embodiments, the working fluid 266 may include a liquid metal such as sodium, potassium, and the like. As discussed in the embodiment of FIGS. 2-3, the evaporator portion 234a is configured to absorb heat from the bypass compressed fluid 23 in the clearance 221, thereby evaporating the working fluid 266. The condenser portion 234c is configured to release heat to a main compressed fluid 15 in a compressor discharge cavity 236, thereby condensing the working fluid 266. The transport portion 234b may be configured to transport i) the vaporized working fluid 266 from evaporator portion 234a to the condenser portion 234c through the sealed chamber, and ii) the condensed working fluid 266 from the condenser portion 234c to the evaporator portion 234a through the wick 264. In one or more embodiments, each of the plurality of heat pipes 234 may be fabricated using a material having high thermal conductivity. For example, the material may include, but not limited to, copper nitrate or aluminum nitrate. In certain embodiments, each of the plurality of heat pipes 234 may be a looped heat pipe. In some embodiments, each of the plurality of heat pipes 234 may be insensitive to gravitational force, thereby allowing the condenser portion 234c to recirculate the condensed working fluid 266 to the evaporator portion 234a against the gravitational force through the wick 264 using capillary action/force.

In one embodiment, the plurality of heat pipes 234 disposed at the top section 222a of the compressor discharge casing 280 may have a low thermal conductivity in comparison with the plurality of heat pipes 234 disposed at the bottom section 222b of the compressor discharge casing 280, to enable a uniform heat transfer across the compressor discharge casing 280. In some embodiments, the plurality of heat pipes 234 with a relatively low thermal conductivity may be obtained by varying capillary resistance of the respective heat pipe 234. In some embodiments, the capillary resistance may be varied by varying a material of the wick 264 in the corresponding heat pipe 234. For example, the material of the wick 264 may include copper nitrate or aluminum nitrate. For example, the wick 264 in the plurality of heat pipes 234 disposed at the top section 222a may have relatively high capillary resistance in comparison with the wick 264 used in the plurality of heat pipes 234 disposed at the bottom section 222b. In some other embodiments, the capillary resistance may be varied by varying thickness of the wick 264 in the corresponding heat pipe 234. For example, the wick 264 in the plurality of heat pipes 234 disposed at the top section 222a may have a first thickness and the wick 264 in the plurality of heat pipes 234 disposed at the bottom section 222b may have a second thickness different from the first thickness. For example, the first thickness may be greater than the second thickness.

Although not illustrated, in certain embodiments, the plurality of heat pipes disposed around the compressor discharge casing 280 may have varied lengths. For example, the plurality of heat pipes 234 disposed at the top section 222a may have a first length and the plurality of heat pipes 234 disposed at the bottom section 222b may have a second length different from the first length. For example, the first length may be greater than the second length. The plurality of heat pipes 234 having varying length may also enable a uniform heat transfer across the compressor discharge casing 280. Thus, the plurality of heat pipes 234 may be indifferent (insensitive) to gravity, thereby preventing distortion or bulging of the compressor discharge casing 280 due to varied heat transfer rate along the compressor discharge casing 280.

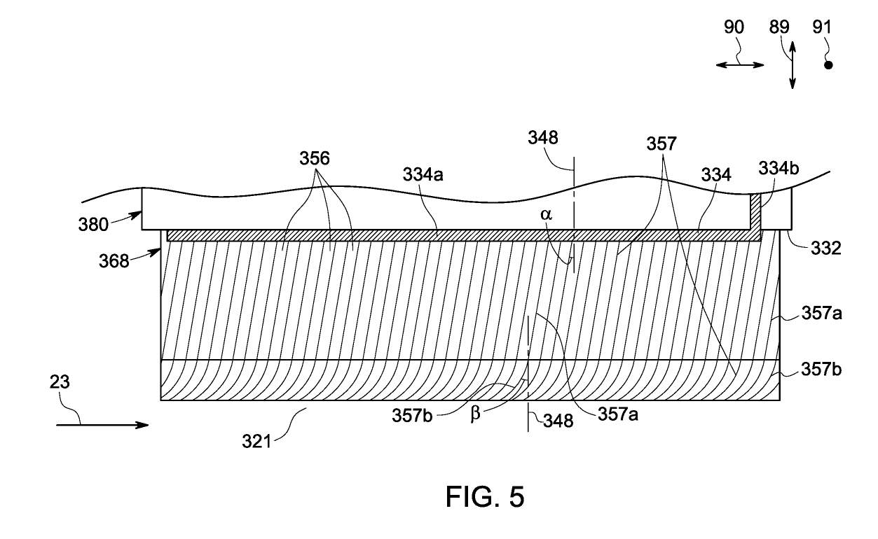

FIG. 5 illustrates a schematic side view of a portion of a heat pipe 334 and the abradable seal component 368 in accordance with one example embodiment. The abradable seal component 368 include a plurality of honeycomb cells 356. In this example embodiment, each of the plurality of honeycomb cell 356 includes the plurality of radial sidewalls 357. Further, each of the plurality of radial sidewalls 357 includes a first portion 357a and a second portion 357b. The first portion 357a is operatively coupled to the surface 332 of the stationary component such as a compressor discharge casing 380 and the second portion 357b extends from the first portion 357a towards the clearance 324 defined between the compressor discharge casing 380 and a rotatable component such as mid-shaft 82 (as shown in FIG. 2). In the embodiment of FIG. 5, the first portion 357a is bent relative to a radial axis 348 of the abradable seal component 368. In certain embodiments, the first portion 357a is bent at an angle “α” which is in a range from 5 degrees to 15 degrees. The second portion 357b is also bent relative to the radial axis 348 of the abradable seal component 368 in the embodiment of FIG. 5. In certain embodiments, the second portion 357b is bent at an angle “β” in a range from 25 degrees to 45 degrees. In one embodiment, the second portion 357b has a radial height in a range from 25 percent to 40 percent of the first portion 357a. In one embodiment, the first portion 357a has a radial height in a range from 8 mm to 10 mm. In one embodiment, the heat pipe 334 includes an evaporator portion 334a and a transport portion 334b, and a condenser portion (not shown). The evaporator portion 334a is disposed in the abradable seal component 368. For example, the evaporator portion 334a is disposed in the first portion 357a proximate to the surface 332 of the compressor discharge casing 380. The transport portion 334b extends from the evaporator portion 334a to a compressor discharge cavity (not shown) through the surface 332 of the compressor discharge casing 380. Although not illustrated, the abradable seal component 368 may include a plurality of grooves. In one such example embodiment, individual grooves of the plurality of grooves may be spaced apart from each other along an axial direction of a turbomachine and extending along a circumferential direction of the turbomachine.

During operation, flow of a bypass compressed fluid 23 may be regulated by diverting a portion of the bypass compressed fluid 23 from the clearance 321 to the plurality of honeycomb cells 356. The second portion 357b of each radial sidewall 357 facilitates to divert the portion of the bypass compressed fluid 23 to each honeycomb cell 356. As a result, the portion of the bypass compressed fluid 23 is entrapped within each of the plurality of honeycomb cells 356, thereby generating a recirculation flow of the bypass compressed fluid 23 in each of the plurality of honeycomb cells 356. The entrapment and the recirculation of the bypass compressed fluid 23 may result in regulating the flow of the bypass compressed fluid 23 through the clearance 321. In one embodiment, a swirling motion of the bypass compressed fluid 23 is therefore reduced in the plurality of honeycomb cells 356, resulting in generating windage heat along the clearance 321. In one such example embodiment, the heat pipe 334 may absorb the heat from the abradable seal component 368 through the evaporator portion 334a, transport the heat from the evaporator portion 334a to the condenser portion 334c through the transport portion 334b, and dissipate the heat in the compressor discharge cavity through the condenser portion. Thus, the heat pipe 334 may regulate windage heat generated along the clearance 321 of the turbomachine.

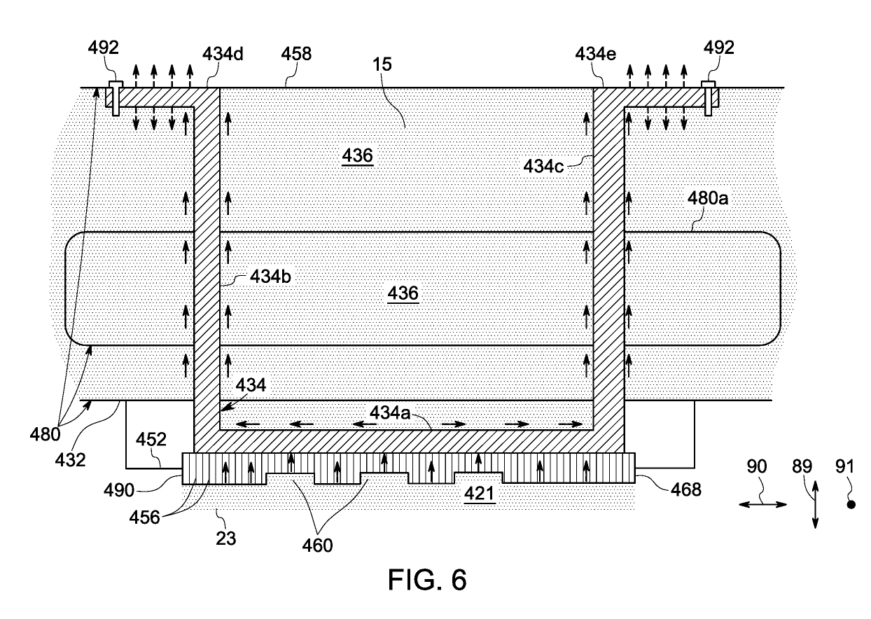

FIG. 6 illustrates a schematic side view of a vapor chamber 434 and the abradable seal component 468 in accordance with one example embodiment. In the illustrated embodiment, a backing plate 452 is coupled to a surface 432 of a stationary component such as a compressor discharge casing 480. The abradable seal component 468 is coupled to the backing plate 452. For example, the abradable seal component 468 is disposed in a slot 490 defined in a first peripheral side portion of the backing plate 452 configured to face a rotatable component of the turbomachine. In some embodiments, the abradable seal component 468 includes a plurality of honeycomb cells 456 disposed adjacent to each other along an axial direction 90 and a circumferential direction 91 of the turbomachine. Further, the abradable seal component 468 includes a plurality of grooves 460 configured to be disposed facing teeth of the rotatable component. In some embodiments, individual grooves of the plurality of grooves 460 are spaced apart from each other along the axial direction 90 and extending along the circumferential direction 91.

The vapor chamber 434 is operatively coupled to the abradable seal component 468 through the backing plate 452. In some embodiments, the vapor chamber 434 includes an evaporator portion 434a, transport portions 434b, 434c, and condenser portions 434d, 434e. In the illustrated embodiment, the evaporator portion 434a is disposed in a backing plate 452 and the transport portions 434b, 434c extends through a surface 432 of the compressor discharge casing 480. For example, the evaporator portion 434a is disposed contacting the abradable seal component 468, the condenser portions 434d, 434e are located in a compressor discharge cavity 436, and the transport portions 434b, 434c extend through the compressor discharge casing 480 via through-holes formed in the compressor discharge casing 480. In example embodiment, the transport portions 434b, 434c extends through an inner barrel 480a of the compressor discharge casing 480. It should be noted herein that during operation, the compressor discharge cavity 436 is configured to receive a main compressed fluid 15 from a compressor of the turbomachine. The evaporator portion 434a extends along a second peripheral side portion opposite to the first peripheral side portion of the backing plate 452, such that it contacts the abradable seal component 468. The condenser portions 434d, 434e extend in opposite direction along a peripheral side portion 92b of an intermediate wall 458 of the compressor discharge casing 480. Further, the condenser portions 434d, 434e are coupled to the intermediate wall 458 via a clamping mechanism, such as bolts 492. Similar to the heat pipe 234 of the embodiment of FIG. 4, the vapor chamber 434 may include a chamber casing and a wick disposed within the chamber casing. The vapor chamber 434 may further include a working fluid disposed within the hermetically sealed chamber casing. In such embodiments, the vapor chamber is configured to absorb heat from bypass compressed fluid 23 in the clearance 421 through the working fluid and transfer the heat to main compressed fluid 15 in the compressor discharge cavity 436. The vapor chamber 434 is configured to transfer heat in multiple directions such as along the circumferential direction 91, the axial direction 90, and a radial direction 89 of the turbomachine. The vapor chamber 434 may be fabricated using a material having high thermal conductivity. For example, the material may include copper nitrate or aluminum nitrate.

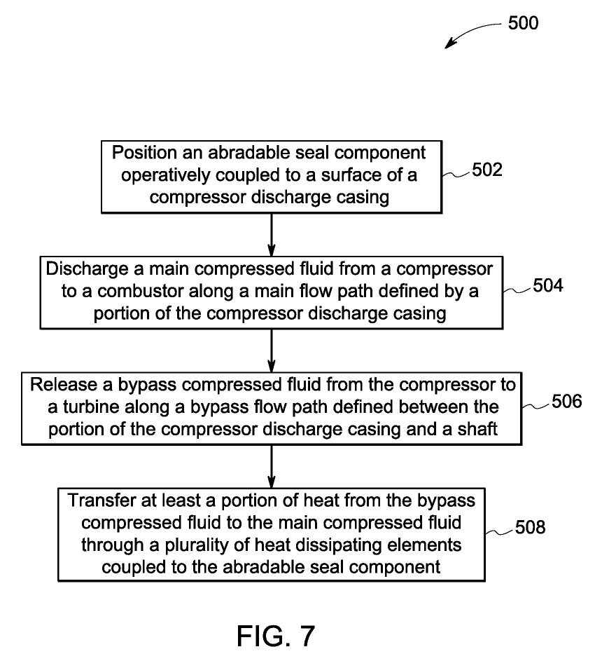

FIG. 7 is a flow diagram of a method 500 for regulating temperature along a clearance of a turbomachine in accordance with one exemplary embodiment. The method 500 includes a step 502 of positioning an abradable seal component operatively coupled to a surface of a compressor discharge casing. In some embodiment, the abradable seal component includes a plurality of honeycomb cells disposed adjacent to each other along an axial direction and a circumferential direction of the turbomachine. In one embodiment, each honeycomb cell includes a plurality of radial sidewalls, where each radial sidewall includes a first portion operatively coupled to the surface and a second portion extending from the first portion towards the clearance. The second portion is bent relative to a radial axis of the turbomachine. In one such example embodiment, the step 502 of positioning the abradable seal component may include forming the abradable seal component directly on a surface of the stationary component or on a backing plate using an additive manufacturing technique. In some other embodiments, the abradable seal component may include a plurality of annular rings spaced apart from each other and disposed along an axial direction of the turbomachine or a plurality of annular rings. In one such example embodiment, the step 502 of positioning the abradable seal component may include receiving the abradable seal component and coupling the abradable seal component to the surface of the stationary component by brazing. In some embodiments, providing the abradable seal component includes coupling a backing plate to the compressor discharge casing and slidably coupling the abradable seal component to the backing plate. In certain embodiments, the abradable seal component may be made of metal powders such as aluminum, steel, and the like.

Further, the method 500 includes a step 504 of a discharging a main compressed fluid from a compressor to a combustor along a main flow path defined by a portion of the compressor discharge casing. For example, the compressor of the turbomachine is configured to discharge a substantially large portion of the compressed fluid as the main compressed fluid to the combustor. The combustor is configured to burn a mixture of a fuel and the main compressed fluid to generate an exhaust gas stream. The turbine is configured to receive the exhaust gas stream and expand the exhaust gas stream through a plurality of stages of the turbine to convert energy in the exhaust gas stream to work.

The method 500 further includes a step 506 of releasing bypass compressed fluid from the compressor to a turbine of the turbomachine along a bypass flow path defined between the portion of the compressor discharge casing and a shaft. In certain embodiments, the bypass compressed fluid may be used for cooling one or more components such as angel wings and/or rub strips of an intra-stage seal, or to purge into the main gas path of the turbine to avoid hot gas ingestion. In some embodiments, the shaft is coupled to the compressor and the turbine. The shaft includes teeth and the abradable seal component is disposed facing the teeth to define a clearance there between the abradable seal component and the shaft.

The method 500 further includes a step 508 of transferring at least a portion of heat from the bypass compressed fluid to the main compressed fluid through a plurality of heat dissipating elements coupled to the abradable seal component. In certain embodiments, each of the plurality of heat dissipating elements extends from the abradable seal component through the surface of the compressor discharge casing to a compressor discharge cavity. In one such example embodiment, the abradable seal component functions as fins to transport heat generated by the bypass compressed fluid along the clearance towards the plurality of heat dissipating elements. Further, the plurality of heat dissipating elements is configured to dissipate the heat from the abradable seal component to the main compressed fluid in a compressor discharge cavity via the abradable seal component and the plurality of heat dissipating elements. In some other embodiments, transferring at least the portion of heat from the bypass compressed fluid to the main compressed fluid includes dissipating the heat through the plurality of heat dissipating elements operatively coupled to the abradable seal component via the backing plate. In some embodiments, at least one of the plurality of heat dissipating elements includes a heat pipe. In some other embodiments, at least one of the plurality of heat dissipating elements includes a vapor chamber. In some other embodiments, the plurality of heat dissipating elements includes a heat pipe or a vapor chamber or combinations thereof.

In certain embodiments, the method 500 further includes regulating a flow of the bypass compressed fluid along the clearance using a plurality of grooves formed in the abradable seal component. For example, the plurality of grooves, the teeth in a rotatable component may be configured to regulate the flow of the bypass fluid along the clearance. In some embodiments, individual grooves of plurality of grooves may be spaced apart from each other along an axial direction of a turbomachine and extends along a circumferential direction of the turbomachine.

In accordance with one or more embodiments discussed herein, the plurality of heat dissipating elements is configured to regulate windage heating along a clearance of a turbomachine by dissipating heat away from the clearance. In certain embodiments, usage of the plurality of heat dissipating elements in a clearance (e.g., a wheel space clearance) defined between a compressor discharge casing and a mid-shaft allows to reduce an amount of the bypass compressed fluid been circulated from a compressor to a turbine. Further, effective regulation of the temperature in the wheel space clearance allows the compressor to optimize compression ratio of the compressed fluid. The plurality of heat dissipating elements may indirectly improve life of the downstream components such as angel wings, rotor, and rub-strips of an intra-stage seal, which are disposed downstream relative to an abradable seal component. The usage of the plurality of heat dissipating elements may reduce a need to use a high temperature alloy material along the clearance of the turbomachine, thereby significantly reducing cost and design change required to the rotatable component of the turbomachine.

While only certain features of embodiments have been illustrated and described herein, many modifications and changes will occur to those skilled in the art. It is, therefore, to be understood that the appended embodiments are intended to cover all such modifications and changes as falling within the spirit of the invention.

1. A turbomachine comprising:
a stationary component;
a rotatable component comprising teeth;
an abradable seal component operatively coupled to a surface of the stationary component and disposed facing the teeth to define a clearance there between the abradable seal component and the rotatable component; and
a plurality of heat dissipating elements coupled to the abradable seal component, wherein each of the plurality of heat dissipating elements extends from the abradable seal component through the surface of the stationary component to a turbomachine cavity.

2. The turbomachine of claim 1, further comprising a backing plate coupled to the surface of the stationary component, wherein the abradable seal component is coupled to the stationary component through the backing plate.

3. The turbomachine of claim 1, wherein the abradable seal component comprises a plurality of honeycomb cells disposed adjacent to each other along an axial direction and a circumferential direction of the turbomachine.

4. The turbomachine of claim 3, wherein each honeycomb cell comprises a plurality of radial sidewalls, wherein each radial sidewall comprises a first portion operatively coupled to the surface of the stationary component and a second portion extending from the first portion towards the clearance, and wherein the second portion is bent relative to a radial axis of the turbomachine.

5. The turbomachine of claim 1, wherein the abradable seal component comprises a plurality of annular rings spaced apart from each other and disposed along an axial direction of the turbomachine.

6. The turbomachine of claim 1, wherein at least one of the plurality of heat dissipating elements comprises a heat pipe.

7. The turbomachine of claim 1, wherein at least one of the plurality of heat dissipating elements comprises a vapor chamber.

8. The turbomachine of claim 1, wherein the stationary component comprises a compressor discharge casing extending from a compressor to a combustor of the turbomachine, wherein the rotatable component comprises a shaft coupled the compressor and a turbine of the turbomachine, and wherein a portion of the compressor discharge casing and the shaft defines a bypass flow path there between, bypassing the combustor.

9. The turbomachine of claim 8, wherein the turbomachine cavity comprises a compressor discharge cavity defined by a portion of the compressor discharge casing of the turbomachine.

10. The turbomachine of claim 9, wherein the plurality of heat dissipating elements is configured to transfer at least a portion of the heat from a bypass compressed fluid in the bypass flow path to a main compressed fluid in the compressor discharge cavity.

11. The turbomachine of claim 1, wherein the stationary component comprises a stator comprising a stator diaphragm, and wherein the turbomachine cavity comprises a diaphragm cavity defined by the stator diaphragm.

12. The turbomachine of claim 1, wherein the stationary component comprises a turbine casing, and wherein the turbomachine cavity comprises a tip shroud cavity defined by a portion of the turbine casing.

13. A heat exchange system for a turbomachine comprising a compressor and a turbine, wherein the heat exchange system comprises:
a bypass flow path defined between a portion of a compressor discharge casing and a shaft, wherein the shaft is coupled to the turbine and the compressor, and wherein a portion of the shaft comprises teeth;
an abradable seal component operatively coupled to a surface of the compressor discharge casing and facing the teeth to define a clearance there between the abradable seal component and the shaft; and
a plurality of heat dissipating elements coupled to the abradable seal component, wherein each of the plurality of heat dissipating elements extends from the abradable seal component through the surface of the compressor discharge casing to a turbomachine cavity, and wherein the plurality of heat dissipating elements is configured to transfer at least a portion of heat away from a flow of a bypass compressed fluid in the bypass flow path.

14. The heat exchange system of claim 13, further comprising a backing plate coupled to the surface of the compressor discharge casing, wherein the abradable seal component is coupled to the compressor discharge casing through the backing plate.

15. The heat exchange system of claim 13, wherein the abradable seal component comprises a plurality of honeycomb cells disposed adjacent to each other along an axial direction and a circumferential direction of the turbomachine.

16. The heat exchange system of claim 15, wherein each honeycomb cell comprises a plurality of radial sidewalls, wherein each radial sidewall comprises a first portion operatively coupled to the surface of the compressor discharge casing and a second portion extending from the first portion towards the clearance, and wherein the second portion is bent relative to a radial axis of the turbomachine.

17. The heat exchange system of claim 13, wherein the abradable seal component comprises a plurality of annular rings spaced apart and disposed adjacent to each other along an axial direction of the turbomachine.

18. The heat exchange system of claim 13, wherein the plurality of heat dissipating elements is configured to transfer at least the portion of the heat from the bypass compressed fluid to a main compressed fluid from the compressor.

19. The heat exchange system of claim 13, wherein at least one of the plurality of heat dissipating elements comprises a heat pipe.

20. The heat exchange system of claim 13, wherein at least one of the plurality of heat dissipating elements comprises a vapor chamber.
